(19) United States
(12) Patent Application Publication
(10) Pub. No.: US 2026/0129723 A1
(43) Pub. Date: May 7, 2026

(54) INDUCTION ENERGY TRANSMISSION SYSTEM

(71) Applicant: BSH Hausgeräte GmbH, Munich (DE)

(72) Inventors: Emilio Plumed Velilla, Zaragoza (ES); Francisco Villuendas Lopez, Zaragoza (ES); Jesus Manuel Moya Nogues, Zaragoza (ES); Jorge Pascual Aza, Zaragoza (ES); Jorge Tesa Betes, Zaragoza (ES); Sergio Llorente Gil, Zaragoza (ES)

(21) Appl. No.: 19/117,421

(22) PCT Filed: Nov. 6, 2023
(86) PCT No.: PCT/EP2023/080836

§ 371 Date: Apr. 1, 2025

(30) Foreign Application Priority Data
Nov. 11, 2022 (EP) 22383089.4

(51) Int. Cl. H05B 6/12; H02J 50/10; H02J 50/60; H02J 50/80

(52) U.S. Cl. CPC H05B 6/1236; H02J 50/10; H02J 50/60; H02J 50/80; H05B 2213/05

(57) ABSTRACT

An induction energy transmission system includes a set-down plate, a supply unit arranged below the set-down plate and including a supply induction element for inductively providing energy, and a set-down unit for setting down on the set-down plate. The set-down unit includes a receiving induction element for receiving the inductively provided energy and a safety switch element for activating and deactivating the receiving induction element. A control unit controls the supply unit and a communications unit wirelessly communicates between the set-down unit and the control unit. The control unit communicates with the set-down unit for exchange of a parameter via the communications unit within a communication time window in which the receiving induction element is deactivated by the safety switch element, and measures a self-inductance of the supply induction element within the communication time window.

The invention relates to an induction energy transmission system according to the preamble of claim 1 and a method for operating an induction energy transmission system according to the preamble of claim 12.

Induction energy transmission systems for the inductive transmission of energy from a primary coil of a supply unit to a secondary coil of a set-down unit are already known from the prior art. For example, induction cooktops are known, the induction cooktops being provided for supplying inductive energy to small household appliances, in addition to inductively heating cooking utensils. A control of the supply unit by a control unit is based on a parameter set, wherein in some known induction energy transmission systems at least one parameter of the parameter set, for example a self-inductance of the secondary coil, an energy requirement or a total electrical load, is transmitted wirelessly, for example via NFC, from the set-down unit to the control unit. In previously known induction energy transmission systems, the parameters of the parameter set are assumed to be constant and can have been stored, for example, in a storage unit of a control unit for controlling the supply unit and/or transmitted from the set-down unit to the control unit, so that individual influences of specific set-down units on some parameters of the parameter set, for example on a self-inductance of a supply induction element, have not yet been taken into account and thus a control is relatively inaccurate and inefficient.

The object of the invention is, in particular but not limited thereto, to provide a generic system having improved properties regarding efficiency. The object is achieved according to the invention by the features of claims 1 and 12, while advantageous embodiments and developments of the invention can be found in the dependent claims.

The invention is based on an induction energy transmission system, in particular an induction cooking system, comprising a set-down plate with a supply unit arranged below the set-down plate and having at least one supply induction element for inductively providing energy, comprising a control unit for controlling the supply unit, comprising at least one set-down unit for setting down on the set-down plate, wherein the set-down unit has at least one receiving induction element for receiving the inductively provided energy and a safety switch element for activating and deactivating the receiving induction element, and comprising a communications unit for wireless communication between the set-down unit and the control unit, wherein the control unit is provided such that, within a communication time window in which the receiving induction element is deactivated by the safety switch element, it communicates with the set-down unit for the exchange of at least one parameter via the communications unit.

It is proposed that the control unit is provided for measuring a self-inductance of the supply induction element within the communication time window.

An induction energy transmission system can be advantageously provided with improved properties regarding efficiency by means of such an embodiment. In particular, a more energy-efficient operation of the induction energy transmission system can be made possible, since a more accurate determination of parameters of a parameter set can be determined by the control unit on the basis of the measurement of the self-inductance of the supply induction element for controlling the supply unit, whereby switching losses can be advantageously reduced and/or an oversupply of the set-down unit can be avoided, for example. Moreover, a cost-efficiency can be advantageously improved, since no additional components are required for the measurement of the self-inductance of the supply induction element. In addition, a safety can be advantageously increased. For example, the measurement of the self-inductance of the supply induction element within the communication time window permits a determination of a switching state of the safety switch element, such that a safety switch element which is jammed can be already detected during the communication time window and corresponding safety measures initiated, for example. Moreover, a detection of, in particular large, foreign objects is possible in a simpler manner and also already within the communication time window on the basis of the measured self-inductance of the supply induction element, such that in such cases corresponding safety measures can be initiated and potential dangers due to foreign objects can be prevented during an operation of the supply unit.

The induction energy transmission system has at least one main functionality in the form of a wireless energy transmission, in particular in a wireless energy supply of set-down units. In an advantageous embodiment, the induction energy transmission system is configured as an induction cooking system with at least one further main function which differs from a purely cooking function, in particular at least one energy supply and an operation of small household appliances. For example, the induction energy transmission system could be configured as an induction oven system and/or as an induction grill system. In particular, the supply unit could be configured as part of an induction oven and/or as part of an induction grill. Preferably, the induction energy transmission system which is configured as an induction cooking system is configured as an induction cooktop system. The supply unit is thus configured, in particular, as part of an induction cooktop. In a further advantageous embodiment, the induction energy transmission system is configured as a kitchen energy supply system and can also be provided for providing cooking functions in addition to a main function in the form of an energy supply and an operation of small household appliances.

A “set-down plate” is intended to be understood to mean, in particular, a plate-like unit of the induction energy transmission system which is provided for setting down at least one set-down unit and/or for positioning at least one food to be cooked. The set-down plate could be configured, for example, as a counter-top, in particular as a kitchen counter-top, or as a sub-region of at least one counter-top, in particular at least one kitchen counter-top, in particular of the induction energy transmission system. Alternatively or additionally, the set-down plate could be configured as a cooktop plate. The set-down plate which is configured as a cooktop plate could form, in particular, at least one part of a cooktop external housing and could form the cooktop external housing at least to a large extent, in particular together with at least one external housing unit to which the set-down plate, which is configured as a cooktop plate, could be connected, in particular in at least one mounted state. Preferably, the set-down plate is produced from a non-metallic material. The set-down plate could be formed, for example, at least to a large extent from glass and/or from glass ceramic and/or from neolith and/or from Dekton and/or from wood and/or from marble and/or from stone, in particular from natural stone, and/or from laminate and/or from plastics and/or from ceramic. In the present document, positional references such as for example “below” or “above” refer to a mounted state of the set-down plate, provided this is not explicitly described otherwise. In the mounted state, the supply unit is preferably arranged below the set-down plate.

A “supply unit” is intended to be understood to mean a unit which in at least one operating state inductively provides energy and which has, in particular, a main functionality in the form of an energy provision. For providing energy, the supply unit has at least one supply induction element which has, in particular, at least one coil, in particular at least one primary coil, and/or is configured as a coil and which inductively provides energy, in particular in the operating state. The supply unit could have at least two, in particular at least three, advantageously at least four, particularly advantageously at least five, preferably at least eight and particularly preferably a plurality of supply induction elements which in each case in the operating state could inductively provide energy and namely, in particular, to a single receiving induction element or to at least two or more receiving induction elements of at least one set-down unit and/or at least one further set-down unit. At least some of the supply induction elements could be arranged in the immediate vicinity of one another, for example in a row and/or in the form of a matrix. Preferably, the supply unit has at least one compensation capacitor which can be connected to the supply induction element electrically in parallel or electrically in series and which can be provided, in particular, for a reactive power compensation.

A “control unit” is intended to be understood to mean an electronic unit which is provided to control and/or to regulate at least the supply unit. The control unit comprises a computing unit and, in particular in addition to the computing unit, a storage unit with at least one control and/or regulating program which is stored therein and which is provided to be executed by the computing unit. The control unit has at least one inverter unit. Preferably, in the operating state the inverter unit carries out a frequency conversion and, in particular, converts a low-frequency AC voltage on the input side into a high-frequency AC voltage on the output side. Preferably, the low-frequency AC voltage has a frequency of at most 100 Hz. Preferably, the high-frequency AC voltage has a frequency of at least 1000 Hz. Preferably, the inverter unit is provided to undertake the adjustment of the energy inductively provided by the at least one supply induction element by adjusting the high-frequency AC voltage. Preferably, the control unit comprises at least one rectifier. The inverter unit has at least one inverter with at least one, preferably at least two, inverter switching element(s). Preferably, for an operation of the at least one supply induction element the inverter switching element generates an oscillating electrical current, preferably at a frequency of at least 15 kHz, in particular of at least 17 kHz and advantageously of at least 20 kHz. Preferably, the inverter unit comprises at least two inverter switching elements which are preferably configured as insulated gate electrode bipolar transistors and particularly advantageously at least one damping capacitor.

A “set-down unit” is intended to be understood to mean a unit which in at least one operating state inductively receives energy and at least partially converts the inductively received energy into at least one further energy form for providing at least one main function. For example, the energy inductively received by the set-down unit could be converted in the operating state, in particular directly, into at least one further energy form, such as for example into heat. Alternatively or additionally, the set-down unit could have at least one electrical consumer, for example an electric motor or the like. The set-down unit has at least one receiving unit with a receiving induction element for receiving the inductively provided energy. The receiving unit could have, for example, at least two, in particular at least three, advantageously at least four, particularly advantageously at least five, preferably at least eight and particularly preferably a plurality of receiving induction elements which, in particular in the operating state, in each case could inductively receive energy, in particular from the supply induction element. The set-down unit could be configured, for example, as a cooking utensil. The cooking utensil preferably has at least one food receiving space and in the operating state converts the inductively received energy at least partially into heat for heating food arranged in the food receiving space. Preferably, the set-down unit which is configured as a cooking utensil has at least one further unit for providing at least one further function which goes beyond purely heating food and/or deviates from heating food. For example, the further unit could be configured as a temperature sensor or as a mixer unit or the like. Alternatively, the set-down unit could be configured as a small household appliance. Preferably, the small household appliance is a location-independent household appliance which has at least the receiving induction element and at least one functional unit which in an operating state provides at least one household appliance function. “Location-independent” is intended to be understood to mean in this context that the small household appliance can be freely positioned in a household by a user and in particular without aids, in particular in contrast to a large household appliance which is fixedly positioned and/or installed at a specific position in a household, such as for example an oven or a refrigerator. Preferably, the small household appliance is configured as a small kitchen appliance and in the operating state provides at least one main function for processing food. The small household appliance, without being limited thereto, could be configured for example as a food processor and/or as a blender and/or as a mixer and/or as a grinder and/or as kitchen scales or as a kettle or as a coffee machine or as a rice cooker or as a milk frother or as a deep fat fryer or as a toaster or as a juicer or as a slicing machine, or the like.

The receiving induction element of the set-down unit comprises at least one secondary coil and/or is configured as a secondary coil. In an operating state of the set-down unit, the receiving induction element supplies at least one consumer of the set-down unit with electrical energy. Moreover, it is conceivable that the set-down unit has an energy storage device, in particular an accumulator, which is provided in a charging state for the storage of electrical energy received via the receiving induction element and in a discharging state for the provision of electrical energy to supply a functional unit. Preferably, the receiving unit has at least one compensation capacitor which is connected to the receiving induction element electrically in parallel or electrically in series and which, in particular, can be provided for reactive power compensation.

A “safety switch element” is intended to be understood to mean an element of the set-down unit which is provided to produce and/or to disconnect an electrically conductive connection between the receiving induction element and at least one further electrical and/or electronic element of the set-down unit, for example the compensation capacitor or a different capacitor of a secondary resonant circuit of the set-down unit and/or an electrical consumer of the set-down unit and/or the like. The safety switch element of the set-down unit is provided to activate the receiving induction element during an operating time window and to deactivate the receiving induction element during the communication time window. When the safety switch element is closed, the receiving induction element is activated and a current flow from the receiving induction element to at least one further electrical and/or electronic element(s) of the set-down unit is enabled via the safety switch element. When the switch element is open, the receiving induction element is deactivated and a current flow from the receiving induction element to all further electrical and/or electronic elements of the set-down unit is interrupted by the safety switch element. The safety switch element can be configured as a mechanical and/or electromechanical switch element, in particular as a relay. It is also conceivable that the safety switch element is configured as a semi-conductor switch element, in particular as a transistor, for example as a metal oxide semi-conductor field effect transistor (MOSFET) or organic field effect transistor (OFET), or as an insulated gate electrode bipolar transistor (IGBT) or the like.

The communications unit is preferably provided for bidirectional wireless data transmission i.e. both for wirelessly receiving and for wirelessly transmitting data between the control unit and the set-down unit. Preferably, the communications unit has at least one communication element which is connected to the control unit and, in particular, is provided for wirelessly receiving and transmitting data. Preferably, the communications unit has at least one further communication element which is arranged inside the set-down unit and is provided, in particular, for wirelessly receiving and transmitting data. The communications unit could be provided for a wireless data transmission between the set-down unit and the control unit via RFID, or via WIFI, or via Bluetooth or via ZigBee or for wireless data transmission according to a different suitable standard. Preferably, the communications unit is provided for a wireless data transmission between the set-down unit and the control unit via NFC. Preferably, the control unit is provided to receive the at least one parameter of the parameter set wirelessly from the set-down unit and namely by means of the communications unit.

An exchange of the at least one parameter between the set-down unit and the control unit preferably takes place wirelessly by means of the communications unit. Preferably, the set-down unit is provided to transmit the at least one parameter, preferably wirelessly by means of the communications unit, to the control unit within the communication time window, wherein the parameter is a parameter of a parameter set which the control unit uses for controlling the supply unit. A “parameter set” is intended to be understood to mean a plurality of at least two parameters which the control unit uses for controlling the supply, and on the basis of which the control unit controls the energy provided inductively by the supply unit according to a type of set-down unit and/or according to a current operating state of the set-down unit which can be selected, in particular, by a user of the induction energy transmission system. The parameter set preferably comprises at least one constant structural and/or geometric characteristic variable of the supply induction element and/or the receiving induction element. Structural and/or geometric characteristic variables could comprise, for example without being limited thereto, a shape and/or size, in particular a radius and/or internal diameter and/or an external diameter, and/or a cross-sectional surface and/or a number of windings and/or a material and/or a spatial position of the receiving induction element within the set-down unit, and/or be a vertical spacing of the supply induction element from the set-down plate and/or the like. Preferably, at least one parameter of the parameter set comprises an electrical characteristic variable, which is variable in particular over time, of the supply induction element and/or the receiving induction element, for example values of electrical resistances and/or impedances in a primary switching circuit of the supply unit and/or in a secondary switching circuit of the receiving unit and/or inductances, in particular self-inductances, and/or magnetic flux densities of the supply induction element and/or the receiving induction element and/or a resonance frequency and/or a material constant, for example a magnetic permeability of a magnetic flux bundling element of the supply unit and/or the receiving unit. Moreover, at least one parameter of the operating parameter set can comprise at least one operating characteristic variable of the set-down unit, for example a maximum power and/or a minimum power and/or a number of power stages and/or a number and/or type of operable electrical loads and/or a voltage and/or current intensity required in an operating state.

A “communication time window” is intended to be understood to mean a time period within which the induction energy transmission system is in an operating state, wherein the supply unit is deactivated by the control unit and a communication connection is present between the control unit and the set-down unit via the communications unit. An “operating time window” is intended to be understood to mean a time period within which the induction energy transmission system is in an operating state, wherein the supply unit is activated by the control unit. A communication connection between the control unit and the set-down unit can be present or interrupted via the communications unit within the operating time window.

The control unit could be provided to measure directly the self-inductance of the supply induction element. Preferably, the control unit is provided to measure indirectly the self-inductance of the supply induction element. Preferably, an indirect measurement of the self-inductance of the supply induction element is carried out by the control unit by measuring an average current intensity at the output of the inverter unit, by measuring an average voltage at the output of the inverter unit and by measuring an average power provided during a measuring process via the inverter unit, wherein the control unit is provided to determine the self-inductance by means of at least one calculation rule, in particular one or more formulae, from the average current intensity, the average voltage and the average power.

In the present document, numerical terms, such as for example “first” and “second”, which are placed in front of specific terms serve merely for differentiating between objects and/or associating objects with one another and do not imply an existing total number and/or ranking of the objects. In particular, a “second object” does not necessarily imply the presence of a “first object”.

“Provided” is intended to be understood to mean specifically programed, designed and/or equipped. An object being provided for a specific function is intended to be understood to mean that the object fulfills and/or performs this specific function in at least one use state and/or operating state.

It is further proposed that the control unit is provided to use the measured self-inductance for determining a parameter set for controlling the supply unit within an operating time window. As a result, an efficiency can be advantageously further improved. In particular, a parameter set which is adapted to the set-down unit can be determined by the control unit, such that a particularly targeted control of the supply unit and thus a particularly efficient and low-loss operation of the supply unit can be made possible. For example, the control unit can be provided to use the measured self-inductance for determining the parameter set for controlling the supply unit within the operating time window, since it compares the measured self-inductance of the supply induction element with a self-inductance of the supply induction element stored as a parameter of the parameter set within the storage unit.

It is also proposed that the control unit is provided to determine at least one correction factor of at least one parameter of the parameter set and to use the measured self-inductance as an initial value therefor. As a result, an efficiency can be advantageously further improved. For example, in the case of a deviation between the stored self-inductance and the measured self-inductance the control unit can be provided to determine the correction factor from a quotient between the stored self-inductance and the measured self-inductance. Further methods appearing expedient to the person skilled in the art for calculating the at least one correction factor on the basis of the measured self-inductance are also conceivable, for example by means of one or more regression equation(s) which contain the measured self-inductance as an initial value.

It is further proposed that the control unit is provided to determine the measured self-inductance for determining a new parameter set for controlling the supply unit. As a result, an efficiency can be advantageously further improved. For example, the control unit can be provided to replace at least one parameter of the parameter set, which can be the stored self-inductance, by the measured self-inductance and thus to determine the new parameter set.

Moreover, it is proposed that the control unit is provided to determine a switching state of the safety switch element on the basis of the measured self-inductance. Such an embodiment can advantageously increase safety. The safety switch element can either be in a first switching state in which it is closed or in a second switching state in which it is open, wherein a self-inductance of the supply induction element measured by the control unit in the first switching state of the safety switch element differs from a self-inductance of the supply induction element measured by the control unit in the second switching state. In particular, the measured self-inductance of the supply induction element is lower in the first switching state of the safety switch element than in the second switching state. Moreover, it is proposed that the control unit is provided at least to initiate at least one safety measure in the event that a safety switch element is closed during the communication time window. This can advantageously further increase safety. In particular, a safety switch element which is defective, for example jammed, can be detected on the basis of the measured self-inductance, so that dangers associated therewith can be prevented. The safety measure which the control unit at least initiates in the case of a safety switch element being closed during the communication time window, for example without being limited thereto, can be blocking a power operation of the supply unit and/or an output of a warning message to a user, for example via an output unit of the induction energy transmission system.

It is further proposed that the control unit is provided to carry out within the communication time window an object detection of objects located on the set-down plate. This can advantageously increase an case of use and safety. Preferably, the object detection is carried out on the basis of the self-inductance of the supply induction element measured by the control unit, wherein different objects located above the set-down plate can be differentiated from one another by the control unit on the basis of the measured self-inductance of the supply induction element. An “object” is intended to be understood to mean in this context an at least partially metallic element which is located above the set-down plate and which interacts with an alternating electromagnetic field provided by the supply induction element. The object can be, for example, the receiving induction element of the set-down unit and/or a conventional cooking utensil, for example a metallic cooking pot or the like, or a foreign object. A “foreign object” is intended to be understood to mean in this context, in particular, an at least partially metallic element, for example a metallic item of cutlery or the like which is not intended to receive the energy inductively provided by the supply unit. Moreover, it is proposed that the control unit is provided to use the measured self-inductance of the supply induction element for differentiating between the set-down units and foreign objects. This can advantageously further increase safety. Moreover, it is proposed that the control unit is provided to initiate at least one safety measure in the event that a foreign object is detected. This can advantageously increase safety even further. In particular, it is possible to prevent a risk of heating and/or energy supply operation by the supply unit in the case of a foreign object located above the set-down plate. The safety measure which the control unit at least initiates in the case of a detection of a foreign object, for example without being limited thereto, can be a blocking of a power operation of the supply unit and/or an output of a warning message to a user, for example via the output unit of the induction energy transmission system.

The invention further relates to a set-down unit, in particular a small household appliance, of an induction energy transmission system according to one of the above-described embodiments. Such a set-down unit is characterized, in particular, by an increased level of efficiency in an operation within the induction energy transmission system.

The invention also relates to an induction household appliance, in particular an induction cooktop, of an induction energy transmission system according to one of the above-described embodiments which comprises the supply unit and the control unit. Such an induction household appliance is characterized by, in particular, in increased level of efficiency in an operation within the induction energy transmission system.

The invention is also based on a method for operating an induction energy transmission system, in particular an induction cooking system, in particular as claimed in one of the preceding claims, comprising a set-down plate with a supply unit arranged below the set-down plate and having at least one supply induction element for inductively providing energy, comprising at least one set-down unit for setting down on the set-down plate, wherein the set-down unit has at least one receiving induction element for receiving the inductively provided energy and a safety switch element for activating and deactivating the receiving induction element, wherein at least one parameter is exchanged within a communication time window in which the receiving induction element is deactivated by the safety switch element.

It is proposed that a self-inductance of the supply induction element is measured within the communication time window. A particularly efficient and safe operation of the induction energy transmission system can be advantageously made possible by such a method.

The induction energy transmission system is not intended to be limited to the above-described use and embodiment. In particular, the induction energy transmission system can have a number of individual elements, components and units which deviates from a number mentioned herein for fulfilling a mode of operation described herein.

Further advantages are found in the following description of the drawing. An exemplary embodiment of the invention is shown in the drawing. The drawing, the description and the claims contain numerous features in combination. The person skilled in the art will also expediently consider the features individually and combine them to form further meaningful combinations.

In the drawing:

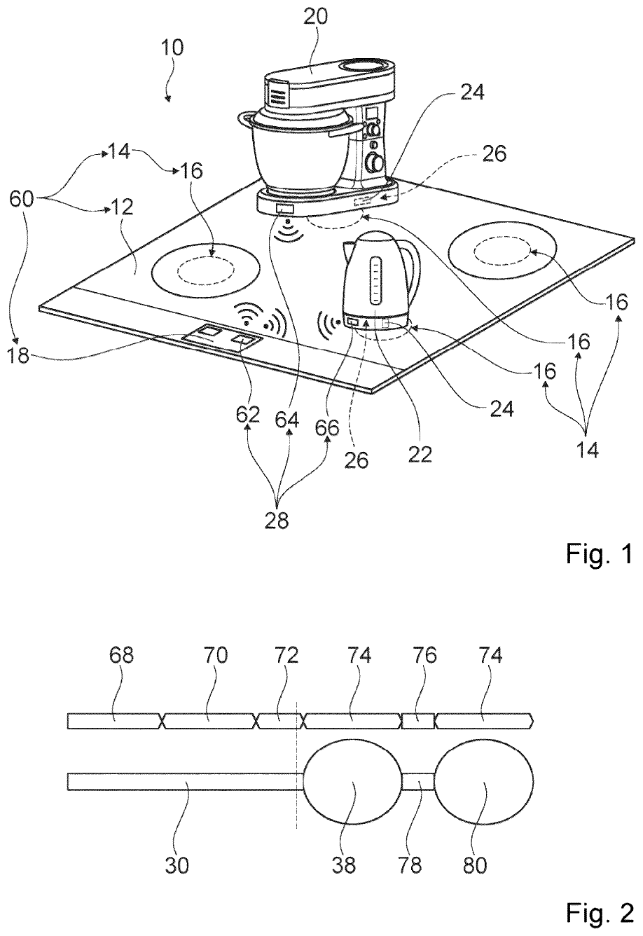

FIG. 1 shows an induction energy transmission system with a supply unit which has at least one supply induction element, a control unit for controlling the supply unit, a set-down unit and a further set-down unit, which in each case have a receiving induction element, in a schematic view,

FIG. 2 shows a schematic diagram for showing a communication time window and an operating time window,

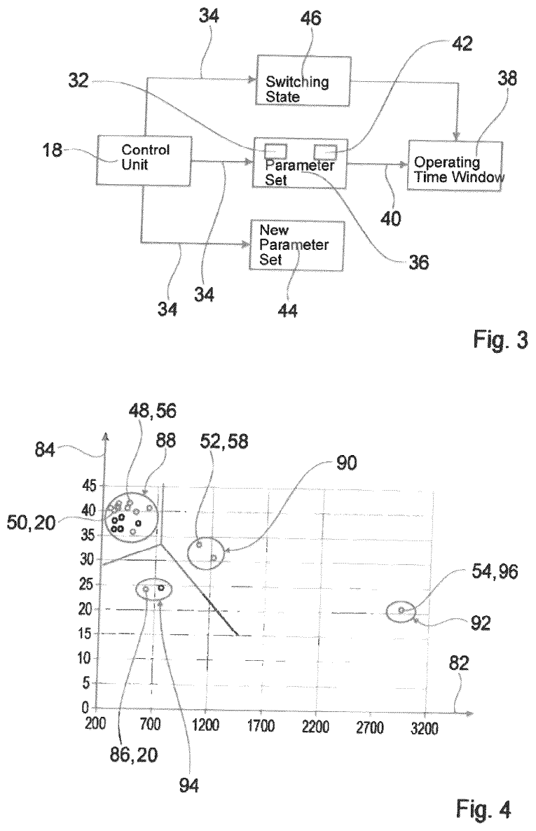

FIG. 3 shows a schematic block diagram for showing a mode of operation of the control unit,

FIG. 4 shows a schematic diagram for showing the mode of operation of an object detection by the control unit,

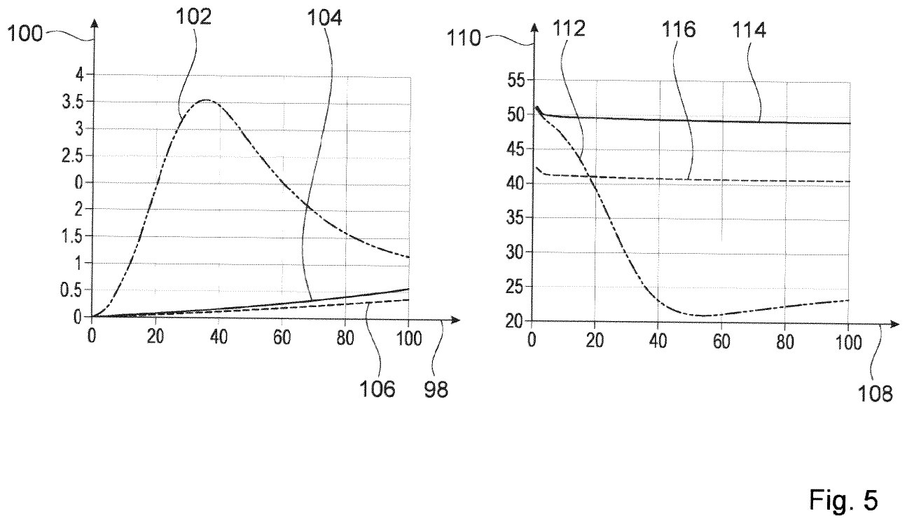

FIG. 5 shows two schematic diagrams for showing the progressions of an equivalent impedance and a self-inductance of the supply induction element and

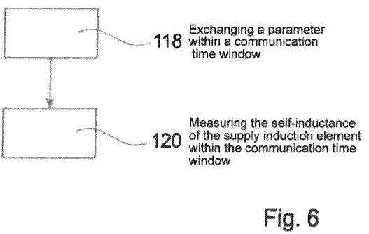

FIG. 6 shows a schematic process flow diagram for showing a method for operating the induction energy transmission system.

FIG. 1 shows an induction energy transmission system 10 in a schematic view. The induction energy transmission system 10 has a set-down plate 12. The induction energy transmission system 10 is configured in the present case as an induction cooking system and comprises an induction household appliance 60. In the present case, the induction household appliance 60 is configured as an induction cooktop. The set-down plate 12 is configured as a cooktop plate and in the present case part of the induction household appliance 60.

The induction energy transmission system 10 has a supply unit 14. The supply unit 14 has at least one supply induction element 16 which is arranged below the set-down plate 12 for inductively providing energy. In the present case, the supply unit 14 comprises a total of four supply induction elements 16 which are arranged in each case below the set-down plate 12. Alternatively, however, the supply unit 14 could have any other number of supply induction elements 16 which is greater than or equal to one.

The induction energy transmission system 10 has a set-down unit 20. The set-down unit 20 has a receiving induction element 24 for receiving the energy inductively provided by the supply unit 14 and a safety switch element 26 to activate and deactivate the receiving induction element 24. In the present case, the set-down unit 20 is configured as a small household appliance and namely as a food processor. The induction energy transmission system 10 in the present case has a further set-down unit 22. The further set-down unit 22 also has a receiving induction element 24 for receiving the energy inductively provided by the supply unit 14 and a safety switch element 26 to activate and deactivate the receiving induction element 24. The further set-down unit 22 is configured in the present case as a further small household appliance and namely as a kettle.

The induction energy transmission system 10 has a control unit 18 for controlling the supply unit 14. The control unit 18 comprises at least one inverter unit (not shown) for controlling the supply unit 14.

The induction energy transmission system 10 has a communications unit 28. The communications unit 28 is provided for wireless communication between the set-down unit 20 and the control unit 18. In the present case, the communications unit 28 is also provided for wireless communication between the further set-down unit 22 and the control unit 18. The communications unit 28 has a communication element 62 which is connected to the control unit 18 and provided for wirelessly transmitting and receiving data. The communications unit 28 has a further communication element 64 which is arranged in the set-down unit 20 and provided for wirelessly transmitting and receiving data. The communications unit 28 also has a further communication element 66 which is arranged in the further set-down unit 22 and provided for wirelessly transmitting and receiving data. In the present case, the communications unit 28 is configured as an NFC communications unit and provided for wireless data transmission via NFC between the control unit 18 and the set-down unit 20 and/or the further set-down unit 22.

The following description of the mode of operation of the induction energy transmission system 10 is made on the basis of the set-down unit 20, wherein statements which have been made can also be expediently transferred to the further set-down unit 22.

The control unit 18 is provided such that, within a communication time window 30 (see FIG. 2) in which the receiving induction element 24 is deactivated by the safety switch element 26, it communicates with the set-down unit 20 for the exchange of at least one parameter 32 (see FIG. 3) via the communications unit 28.

The control unit 18 is also provided to measure a self-inductance 34 of the supply induction element 16 (see FIG. 3) within the communication time window 30. In the present case, the control unit 18 is provided to measure indirectly the self-inductance 34. For the indirect measurement of the self-inductance 34, the control unit 18 is provided to actuate the inverter unit for operating the supply induction element 16 and to measure an average voltage and an average current intensity at the output of the inverter unit. Moreover, the control unit 18 is provided to determine on the basis of the following equation (1) an equivalent resistance of the supply induction element 16 from an average electrical power for operating the inverter unit and the average current intensity measured at the output of the inverter unit:

$${R}_{eq} = \frac{{P}_{avg}}{{{I}_{rms}}^{2}} \qquad i . ( 1 )$$

wherein in the equation (1) the expression R_{eq} stands for the equivalent resistance, the expression P_{avg} stands for the average electrical power and the expression Iᵣₘₛ stands for the average current intensity measured at the output of the inverter unit.

In addition, the control unit 18 is provided to determine on the basis of the following equation (2) an equivalent impedance of the supply induction element 16:

$${Z}_{eq}^{2} = {V}_{rms}^{2} + {I}_{rms}^{2} \qquad ii . ( 2 )$$

wherein in the equation (2) the expression Z_{eq} stands for the equivalent impedance of the supply induction element 16, the expression Vᵣₘₛ stands for the average voltage measured at the output of the inverter unit and Iᵣₘₛ stands for the average current intensity measured at the outlet of the inverter unit.

The control unit 18 is also provided to determine a reactance of the supply induction element 16 on the basis of the following equation (3):

$$\begin{matrix}ii & \\ {X}_{eq}^{2} = {Z}_{eq}^{2} - {R}_{eq}^{2} . & i . ( 3 )\end{matrix}$$

wherein in the equation (3) the expression X_{eq} stands for the reactance, the expression Z_{eq} stands for the equivalent impedance and the expression R_{eq} stands for the equivalent resistance.

Finally the control unit 18 is provided to determine the self-inductance 34 on the basis of the following equation (4):

$${L}_{eq} = \frac{{X}_{eq}}{2 π f} \qquad ii . ( 4 )$$

wherein in the equation (4) the expression L_{eq} stands for the self-inductance 34, the expression X_{eq} stands for the reactance, the expression π stands for Pi and the expression f stands for a switching frequency at which the control unit 18 operates the inverter unit.

FIG. 2 shows a schematic diagram for showing the communication time window 30 and an operating time window 38. A greeting phase 68 takes place at the start of the communication time window 30. In the greeting phase 68, a first communication takes place between the control unit 18 and the set-down unit 20 via the communications unit 28 which in technical English is also denoted as an “NFC handshake”. In a subsequent exchange phase 70 the at least one parameter 32 (see FIG. 3) is exchanged via the communications unit 28, wherein the control unit 18 makes a power request and communicates a required power demand to the set-down unit 20. In a following measuring and testing phase 72, the self-inductance 34 of the supply induction element 16 is measured, amongst other things. After a successful measuring and testing phase 72, the safety switch element 26 is closed and the control unit 18 activates the supply unit 14. The operating time window 38 starts, the operating time window comprising at least one power phase 74 in which the control unit 18 operates the supply unit 14 in a power operation and the at least one supply induction element 16 inductively provides energy to the receiving induction element 24. A further communication time window 78 can follow the operating time window 38, in which the inductive energy supply is interrupted by the supply induction element 16. The further communication time window 78 can comprise an intermediate communication phase 76, in which a further exchange can take place between the control unit 18 and the set-down unit 20, for example an exchange of at least one further parameter (not shown), for example a changed power demand. A further operating time window 80, which in turn comprises at least one power phase 74, can follow in turn after the further communication time window 78.

FIG. 3 shows a schematic block diagram for showing a mode of operation of the control unit 18. The control unit 18 is provided to use the measured self-inductance 34 for determining a parameter set 36 for controlling the supply unit 14 within the operating time window 38. During the communication time window 30 the control unit 18 receives the parameter 32, for example, wherein this can be a self-inductance of the receiving induction element 24, for example. Moreover at least one parameter 42 of the parameter set 36 can be stored in a storage unit (not shown) of the control unit 18, wherein the parameter 42 can be, for example, a stored self-inductance of the supply induction element 16. For example, the control unit 18 can be provided to use the measured self-inductance 34 for determining the parameter set 36 for controlling the supply unit 14 within the operating time window 38, by comparing the measured self-inductance 34 of the supply induction element 16 with the self-inductance of the supply induction element 16 stored as a parameter 42 of the parameter set 36.

The control unit 18 is provided to determine at least one correction factor 40 of at least one parameter 42 of the parameter set 36 and to use the measured self-inductance 34 as an initial value therefor. For example, in the case of a deviation between the stored self-inductance and the measured self-inductance 34 the control unit 18 can be provided to determine the correction factor 40 from a quotient between the stored self-inductance and the measured self-inductance 34.

The control unit 18 is provided to determine the measured self-inductance 34 for determining a new parameter set 44 for controlling the supply unit 14. For example, the control unit 18 can be provided to replace at least one parameter, for example the parameter 42 of the parameter set 36, by the measured self-inductance 34 and thus to determine the new parameter set 44.

The control unit 18 is provided to determine a switching state 46 of the safety switch element 26 on the basis of the measured self-inductance 34. The mode of operation for the determination of the switching state 46 by the control unit 18 is explained hereinafter by way of FIGS. 4 and 5.

The control unit 18 is provided at least to initiate at least one safety measure in the event that a safety switch element 26 is closed during the communication time window 30. For example, as a safety measure the control unit 18 can block a power operation of the supply unit 14, in the event that the safety switch element 26 is closed during the communication time window 30. In addition, the control unit 18 can output a warning message to the user as a safety measure, for example by means of an output unit (not shown) of the induction energy transmission system 10, in the event that the safety switch element 26 is closed during the communication time window 30.

FIG. 4 shows a schematic diagram for showing a mode of operation of an object detection by the control unit 18. The control unit 18 is provided to carry out within the communication time window 30 an object detection of objects 48, 50, 52, 54 located on the set-down plate 12. The control unit 18 is also provided to use the measured self-inductance 34 for differentiating between set-down units 20, 22 and foreign objects 56, 58.

The equivalent impedance of the supply induction element 16 is plotted in mΩ on an x-axis 82 of the diagram. The measured self-inductance 34 of the supply induction element 16 is plotted in μH on a y-axis 84 of the diagram. Various measuring points of measurements which the control unit 18 carries out within the communication time window 30 are shown in the diagram by way of example. Measuring points which are located within a first region 88 of the diagram represent objects 48, 50 which can be either a set-down unit 20, 22 with the deactivated receiving induction element 24 or smaller metallic foreign objects 56. Measuring points which are located within a second region 90 of the diagram represent large foreign objects, for example an object 52, which is a foreign object 58 in the present case, for example a large steel disk. Measuring points which are located within a third region 92 of the diagram represent a conventional cooking utensil, for example an object 54, which is a cooking pot 96 in the present case. Measuring points which are located in a fourth region 94 of the diagram represent objects which are set-down units 20, 22 with an activated receiving induction element 24.

For example, an object 86 is the set-down unit 20 when the safety switch element 26 is closed. If a measurement value is obtained within the fourth region 94 during the communication time window 30, the control unit 18 concludes therefrom that the safety switch element 30 is closed and initiates the at least one safety measure.

The control unit 18 is also provided at least to initiate at least one safety measure, for example a blocking of the power operation of the supply unit 14 and/or the output of a warning message in the event that a foreign object 56, 58 is detected. If a measurement value is obtained within the second region 90 during the communication time window 30, the control unit 18 concludes the presence of a large foreign object 58 and initiates the at least one safety measure. If a measurement value is obtained in the first region 88 during the communication time window 30, the control unit 18 is provided to use the equivalent impedance of the supply induction element 16 for a more accurate differentiation. For example, on the basis of the equivalent impedance of the supply induction element 16 the control unit 18 identifies the object 50 as the set-down unit 20 with the receiving induction element 24 deactivated. Moreover, on the basis of the equivalent impedance of the supply induction element 16 the control unit 18 identifies, for example, the object 48 as a small foreign object 56, for example as a metallic item of cutlery or the like, and initiates the at least one safety measure.

FIG. 5 shows two schematic diagrams for showing the progressions of the equivalent impedance and the self-inductance 34 of the supply induction element 16. The switching frequency at which the control unit 18 operates the inverter unit for controlling the supply induction element 16 is plotted in kHz on an x-axis 98 of a left-hand diagram of FIG. 5. The equivalent impedance of the supply induction element 16 is plotted in Ω on a y-axis 100 of the left-hand diagram. A first curve 102 in the left-hand diagram shows a progression of the equivalent impedance of the supply induction element 16 over the switching frequency with the set-down unit 20 set-down on the set-down plate 12 when the receiving induction element 24 is activated. A second curve 104 in the left-hand diagram shows a progression of the equivalent impedance of the supply induction element 16 over the switching frequency when the set-down unit 20 is set down on the set-down plate 12 with the receiving induction element 24 deactivated. A third curve 106 in the left-hand diagram shows a progression of the equivalent impedance of the supply induction element 16 over the switching frequency when the set-down units 20, 22 are not set down on the set-down plate 12.

The switching frequency is plotted in kHz on an x-axis 108 of a right-hand diagram of FIG. 5. The self-inductance 34 of the supply induction element 16 is plotted in μH on a y-axis 110 of the right-hand diagram. A first curve 112 in the right-hand diagram shows a progression of the self-inductance 34 over the switching frequency when the set-down unit 20 is set down on the set-down plate 12 with the receiving induction element 24 activated. A second curve 114 in the right-hand diagram shows a progression of the self-inductance 34 over the switching frequency when the set-down unit 20 is set down on the set-down plate 12 with the receiving induction element 24 deactivated. A third curve 116 in the right-hand diagram shows a progression of the self-inductance 34 over the switching frequency when the set-down units 20, 22 are not set down on the set-down plate 12.

As can be seen in the diagrams of FIG. 5, a presence of set-down units 20, 22 on the set-down plate 12 and the switching state of the safety switch element 26 can be determined by the control unit 18 on the basis of the measured self-inductance 34 and/or the equivalent impedance.

FIG. 6 shows a schematic process flow diagram of a method for operating the induction energy transmission system 10. The method comprises at least two method steps 118, 120. In a first method step 118 of the method, at least one parameter 32 is exchanged, and namely between the control unit 18 and the set-down unit 20 by means of the communications unit 28, within the communication time window 30 in which the receiving induction element 24 is deactivated by the safety switch element 26. In a second method step 120 of the method, the self-inductance 34 of the supply induction element 16 is measured within the communication time window 30.

### REFERENCE SIGNS

10 Induction energy transmission system
12 Set-down plate
14 Supply unit
16 Supply induction element
18 Control unit
20 Set-down unit
22 Further set-down unit
24 Receiving induction element
26 Safety switch element
28 Communications unit
30 Communication time window
32 Parameter
34 Self-inductance
36 Parameter set
38 Operating time window
40 Correction factor
42 Parameter
44 New parameter set
46 Switching state
48 Object
50 Object
52 Object
54 Object
56 Foreign object
58 Foreign object
60 Induction household appliance
62 Communication element
64 Further communication element
66 Further communication element
68 Greeting phase
70 Exchange phase
72 Measuring and testing phase
74 Power phase
76 Intermediate communication phase
78 Further communication time window
80 Further operating time window
82 X-axis
84 Y-axis
86 Object
88 First region
90 Region
92 Region
94 Region
96 Cooking pot
98 X-axis
100 Y-axis
102 First curve
104 Second curve
106 Third curve
108 X-axis
110 Y-axis
112 First curve
114 Second curve
116 Third curve
118 First method step
120 Second method step

1-12. (canceled)

13. An induction energy transmission system, in particular an induction cooking system, the induction energy transmission system comprising:
a set-down plate;
a supply unit arranged below the set-down plate and including a supply induction element designed to inductively provide energy;
a set-down unit designed to set down on the set-down plate, the set-down unit comprising a receiving induction element designed to receive the inductively provided energy and a safety switch element designed to activate and deactivate the receiving induction element;
a control unit designed to control the supply unit; and
a communications unit designed to wirelessly communicate between the set-down unit and the control unit,
wherein the control unit is designed to communicate with the set-down unit for exchange of a parameter via the communications unit within a communication time window in which the receiving induction element is deactivated by the safety switch element, and to measure a self-inductance of the supply induction element within the communication time window.

14. The induction energy transmission system of claim 13, wherein the control unit is designed to use the measured self-inductance for determining a parameter set for controlling the supply unit within an operating time window.

15. The induction energy transmission system of claim 14, wherein the control unit is designed to determine a correction factor of a parameter of the parameter set and to use the measured self-inductance as an initial value therefor.

16. The induction energy transmission system of claim 13, wherein the control unit is designed to use the measured self-inductance for determining a new parameter set for controlling the supply unit.

17. The induction energy transmission system of claim 13, wherein the control unit is designed to determine a switching state of the safety switch element based on the measured self-inductance.

18. The induction energy transmission system of claim 13, wherein the control unit is designed to initiate a safety measure when the safety switch element is closed during the communication time window.

19. The induction energy transmission system of claim 13, wherein the control unit is designed to carry out within the communication time window an object detection of objects located on the set-down plate.

20. The induction energy transmission system of claim 13, wherein the control unit is designed to use the measured self-inductance for differentiating between plural set-down units and foreign objects.

21. The induction energy transmission system of claim 13, wherein the control unit is designed to initiate a safety measure when a foreign object is detected.

22. A set-down unit, in particular a small household appliance, of an induction energy transmission system, the set-down unit designed for placement on a set-down plate of the induction energy transmission system and comprising:
a receiving induction element designed to receive an inductively provided energy; and
a safety switch element designed to activate and deactivate the receiving induction element.

23. An induction household appliance, in particular an induction cooktop, of an induction energy transmission system, the induction household appliance comprising:
a set-down plate for placement of a set-down unit;
a supply unit arranged below the set-down plate and including a supply induction element designed to inductively provide energy for a receiving induction element of the set-down unit; and
a control unit designed to control the supply unit, said control unit designed to wirelessly communicate with the set-down unit for exchange of a parameter via a communications unit of the induction energy transmission system within a communication time window in which the receiving induction element is deactivated by a safety switch element of the set-down unit, and to measure a self-inductance of the supply induction element within the communication time window.

24. A method for operating the induction energy transmission system of claim 13, the method comprising:
inductively providing energy by the supply induction element of the supply unit;
transmitting the inductively provided energy to the receiving induction element of the set-down unit;
activating and deactivating the receiving induction element by the safety switch element;
exchanging a parameter within a communication time window in which the receiving induction element is deactivated by the safety switch element; and
measuring a self-inductance of the supply induction element within the communication time window.

25. The method of claim 24, further comprising determining a parameter set as a function of the measured self-inductance for controlling the supply unit within an operating time window.

26. The method of claim 24, further comprising determining a correction factor of a parameter of the parameter set based on the measured self-inductance as an initial value.

27. The method of claim 24, further comprising determining a parameter set for controlling the supply unit based on the measured self-inductance.

28. The method of claim 24, further comprising determining a switching state of the safety switch element based on the measured self-inductance.

29. The method of claim 24, further comprising initiating a safety measure when the safety switch element is closed during the communication time window.

30. The method of claim 24, further comprising carrying out within the communication time window an object detection of objects located on the set-down plate.

31. The method of claim 24, further comprising differentiating between a plurality of set-down units and foreign objects based on the measured self-inductance.

32. The method of claim 24, further comprising initiating a safety measure when a foreign object is detected.
